(19) United States
(12) Patent Application Publication
(10) Pub. No.: US 2012/0186269 A1
(43) Pub. Date: Jul. 26, 2012

(54) SUPPORT BETWEEN TRANSITION PIECE AND IMPINGEMENT SLEEVE IN COMBUSTOR

(75) Inventors: David William Cihlar, Greenville, SC (US); Patrick Benedict Melton, Horse Shoe, NC (US)

(73) Assignee: GENERAL ELECTRIC COMPANY, Schenectady, NY (US)

(21) Appl. No.: 13/013,088

(22) Filed: Jan. 25, 2011

(51) Int. Cl. F02C 7/20

(52) U.S. Cl. 60/796

(57) ABSTRACT

A support between a transition piece and an impingement sleeve in a combustor is disclosed. The support includes a resilient portion, the resilient portion configured to provide dampening between the transition piece and the impingement sleeve. The support further includes a mount portion configured for mounting the support to one of the transition piece or the impingement sleeve. The support further includes a contact portion configured for contacting the other of the transition piece or the impingement sleeve.

### FIELD OF THE INVENTION

The subject matter disclosed herein relates generally to turbine systems, and more particularly to supports between transition pieces and impingement sleeves in combustors of turbine systems.

### BACKGROUND OF THE INVENTION

Turbine systems are widely utilized in fields such as power generation. For example, a conventional gas turbine system includes a compressor, a combustor, and a turbine. During operation of a turbine system, many components of the system may be subjected to significant structural vibrations and thermal expansion. These effects can stress the components and eventually cause the components to fail. For example, in gas turbine systems, the combustor impingement sleeves, which surround the combustor transition pieces, are particularly vulnerable to structural vibrations. Further, both the impingement sleeves and transition pieces are vulnerable to thermal expansion.

Typical arrangements of impingement sleeves and transition pieces include support rings and stiff, inelastic spacers mounted between the impingement sleeves and transition pieces. The spacers are welded between the transition piece and the support ring, and the impingement sleeve fits onto the support ring. The support rings and spacers, however, may not adequately accommodate the structural vibration and thermal expansion of the impingement sleeves and transition pieces. For example, because many spacers are welded between the support rings and transition pieces, the spacers may resist structural vibrations and thermal expansion. This resistance may cause cracking of the support rings as well as of the impingement sleeves and the transition pieces.

Thus, an improved support between an impingement sleeve and a transition piece in a combustor would be desired in the art. For example, a support that provides dampening and stiffness to support the impingement sleeve while accommodating the structural vibrations of the combustor would be advantageous. Further, a support that accommodates thermal expansion would be desired. Additionally, a support that can be optimized for the structural vibration and/or thermal expansion of a particular combustor would be advantageous.

### BRIEF DESCRIPTION OF THE INVENTION

Aspects and advantages of the invention will be set forth in part in the following description, or may be obvious from the description, or may be learned through practice of the invention.

In one embodiment, a support between a transition piece and an impingement sleeve in a combustor is disclosed. The support includes a resilient portion, the resilient portion configured to provide dampening between the transition piece and the impingement sleeve. The support further includes a mount portion configured for mounting the support to one of the transition piece or the impingement sleeve. The support further includes a contact portion configured for contacting the other of the transition piece or the impingement sleeve.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic illustration of a gas turbine system;

FIG. 2 is a side cutaway view of various components of a gas turbine system according to one embodiment of the present disclosure;

FIG. 3 is a perspective view of an impingement sleeve, a transition piece, and a plurality of supports according to one embodiment of the present disclosure;

FIG. 4 is a front view of a support according to one embodiment of the present disclosure;

FIG. 5 is a front view of a support according to another embodiment of the present disclosure;

FIG. 6 is a front view of a support according to another embodiment of the present disclosure;

FIG. 7 is a front view of a support according to another embodiment of the present disclosure;

FIG. 8 is a front view of a support according to another embodiment of the present disclosure; and

FIG. 9 is an enlarged front view of a portion of the support as shown in FIG. 4.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

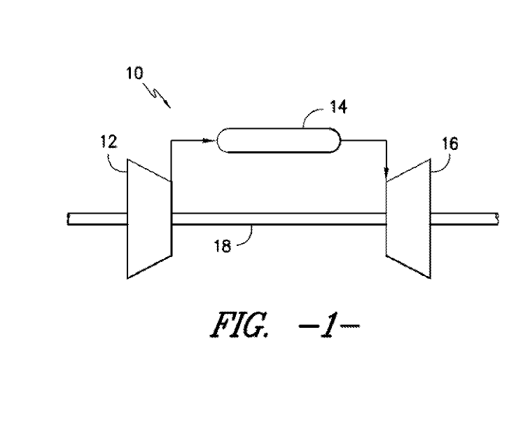

FIG. 1 is a schematic diagram of a gas turbine system 10. The system 10 may include a compressor 12, a combustor 14, and a turbine 16. Further, the system 10 may include a plurality of compressors 12, combustors 14, and turbines 16. The compressors 12 and turbines 16 may be coupled by a shaft 18. The shaft 18 may be a single shaft or a plurality of shaft segments coupled together to form shaft 18.

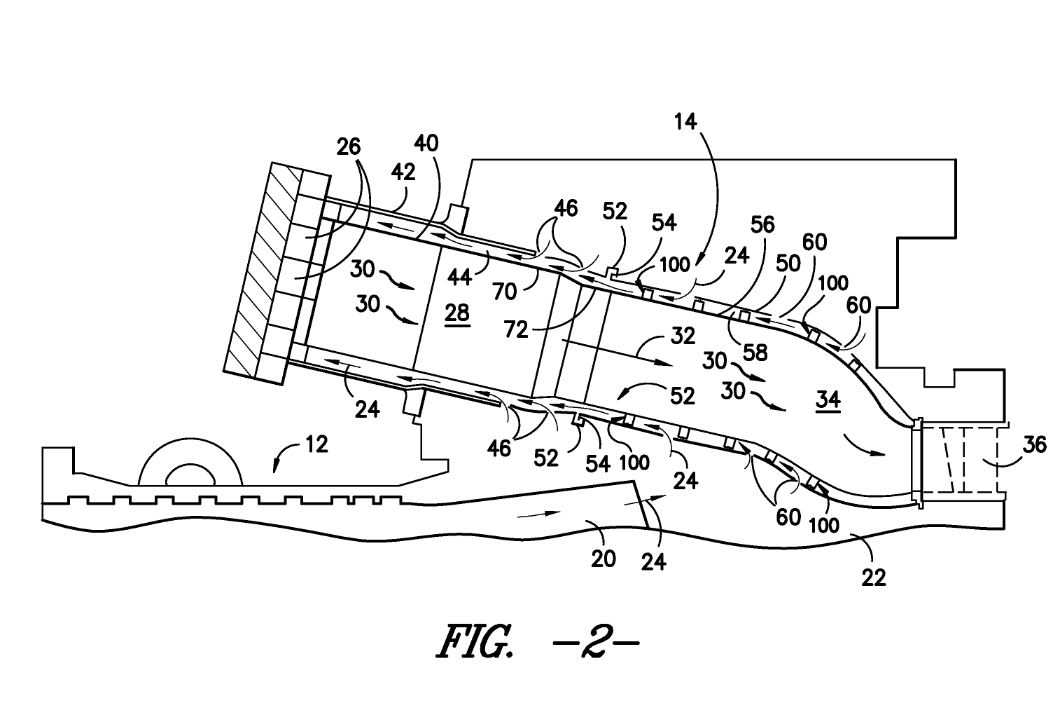

As illustrated in FIG. 2, the combustor 14 is generally fluidly coupled to the compressor 12 and the turbine 16. The compressor 12 may include a diffuser 20 and a discharge plenum 22 that are coupled to each other in fluid communication, so as to facilitate the channeling of a working fluid 24 to the combustor 14. For example, after being compressed in the compressor 12, working fluid 24 may flow through the diffuser 20 and be provided to the discharge plenum 22. The working fluid 24 may then flow from the discharge plenum 22 to the combustor 14, wherein the working fluid 24 is combined with fuel from fuel nozzles 26. After mixing with the fuel, the working fluid 24/fuel mixture may be ignited within combustion chamber 28 to create hot gas flow 30. The hot gas flow 30 may be channeled through the combustion chamber 28 along a hot gas path 32 into a transition piece cavity 34 and through a turbine nozzle 36 to the turbine 16.

The combustor 14 may comprise a hollow annular wall configured to facilitate working fluid 24. For example, the combustor 14 may include a combustor liner 40 disposed within a flow sleeve 42. The arrangement of the combustor liner 40 and the flow sleeve 42, as shown in FIG. 2, is generally concentric and may define an annular passage or flow path 44 therebetween. In certain embodiments, the flow sleeve 42 and the combustor liner 40 may define a first or upstream hollow annular wall of the combustor 14. The flow sleeve 42 may include a plurality of inlets 46, which provide a flow path for at least a portion of the working fluid 24 from the compressor 12 through the discharge plenum 22 into the flow path 44. In other words, the flow sleeve 42 may be perforated with a pattern of openings to define a perforated annular wall. The interior of the combustor liner 40 may define the substantially cylindrical or annular combustion chamber 28 and at least partially define the hot gas path 32 through which hot gas flow 30 may be directed.

Downstream from the combustor liner 40 and the flow sleeve 42, an impingement sleeve 50 may be coupled to the flow sleeve 42. The flow sleeve 42 may include a mounting flange 52 configured to receive a mounting member 54 of the impingement sleeve 50. A transition piece 56 may be disposed within the impingement sleeve 50, such that the impingement sleeve 50 surrounds at least a portion of the transition piece 56. A concentric arrangement of the impingement sleeve 50 and the transition piece 56 may define an annular passage or flow path 58 therebetween. The impingement sleeve 50 may include a plurality of inlets 60, which may provide a flow path for at least a portion of the working fluid 24 from the compressor 12 through the discharge plenum 22 into the flow path 58. In other words, the impingement sleeve 50 may be perforated with a pattern of openings to define a perforated annular wall. Interior cavity 34 of the transition piece 56 may further define hot gas path 32 through which hot gas flow 30 from the combustion chamber 28 may be directed into the turbine 16.

As shown, the flow path 58 is fluidly coupled to the flow path 44. Thus, together, the flow paths 44 and 58 define a flow path configured to provide working fluid 24 from the compressor 12 and the discharge plenum 22 to the fuel nozzles 26, while also cooling the combustor 14.

As discussed above, the turbine system 10, in operation, may intake working fluid 24 and provide the working fluid 24 to the compressor 12. The compressor 12, which is driven by the shaft 18, may rotate and compress the working fluid 24. The compressed working fluid 24 may then be discharged into the diffuser 20. The majority of the compressed working fluid 24 may then be discharged from the compressor 12, by way of the diffuser 20, through the discharge plenum 22 and into the combustor 14. Additionally, a small portion (not shown) of the compressed working fluid 24 may be channeled downstream for cooling of other components of the turbine engine 10.

A portion of the compressed working fluid 24 within the discharge plenum 22 may enter the flow path 58 by way of the inlets 60. The working fluid 24 in the flow path 58 may then be channeled upstream through flow path 44, such that the working fluid 24 is directed over the combustor liner 34. Thus, a flow path is defined in the upstream direction by flow path 58 (formed by impingement sleeve 50 and transition piece 56) and flow path 44 (formed by flow sleeve 42 and combustor liner 40). Accordingly, flow path 44 may receive working fluid 24 from both flow path 58 and inlets 46. The working fluid 24 through the flow path 44 may then be channeled upstream towards the fuel nozzles 26, as discussed above.

During operation of the turbine system 10, the impingement sleeve 50 may vibrate undesirably relative to the transition piece 56. Further, both the impingement sleeve 50 and the transition piece 56 may be subjected to thermal expansion due to the temperatures of the various flows past the impingement sleeve 50 and transition piece 56, such as the working fluid flow 24 and the hot gas flow 30. Thus, devices and apparatus are needed to provide support between the impingement sleeve 50 and the transition piece 56, and to reduce damage to the combustor 14 and turbine system 10 due to vibration and thermal expansion of the impingement sleeve 50 and the transition piece 56.

Thus, as shown in FIGS. 2 through 9, the present disclosure is further directed to a support 100, or a plurality of supports 100, positioned between the impingement sleeve 50 and the transition piece 56 of a combustor 14. As discussed below, the support 100 of the present disclosure has various generally resilient characteristics that allow the support 100 to provide dampening as well as stiffness between the transition piece 56 and the impingement sleeve 50, thus reducing vibrations of the transition piece 56 and the impingement sleeve 50 relative to each other while adequately supporting the impingement sleeve 50. Further, the support 100 allows for thermal expansion of the transition piece 56 and the impingement sleeve 50, while maintaining a relatively tight fit with tight tolerances between the transition piece 56 and the impingement sleeve 50. In exemplary embodiments, the support 100 may advantageously allow for elimination of support rings and stiff, inelastic spacers between the transition piece 56 and impingement sleeve 50.

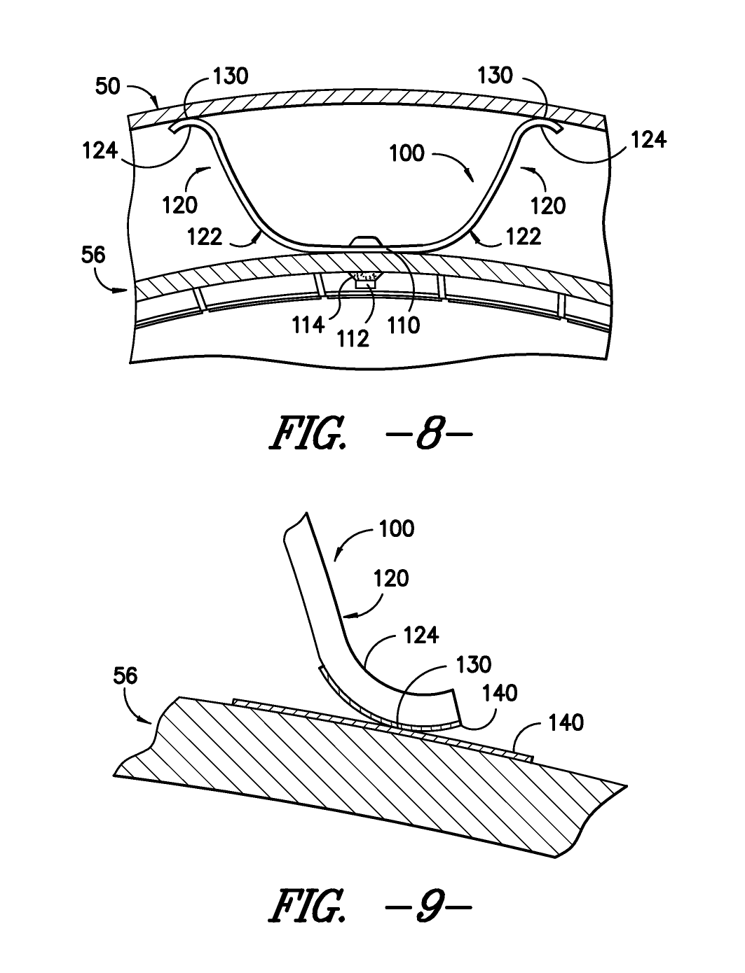

In general, the support 100 is mounted to one of the transition piece 56 or the impingement sleeve 50, and is configured to contact the other of the transition piece 56 or the impingement sleeve 50. For example, in exemplary embodiments as shown in FIGS. 2 through 7 and 9, the support 100 is mounted to the impingement sleeve 50, and is configured to contact the transition piece 56. In alternative embodiments as shown in FIG. 8, however, the support 100 may be mounted to the transition piece 56, and may be configured to contact the impingement sleeve 50.

As mentioned above, a support 100 or a plurality of supports 100 may be positioned between the impingement sleeve 50 and the transition piece 56. In exemplary embodiments, at least a portion of the supports 100 may be positioned at or adjacent to the forward end of the one of the transition piece 56 or the impingement sleeve 50, which is the end of the one of the transition piece 56 or the impingement sleeve 50 generally adjacent to the combustor liner 40 and/or the flow sleeve 42. However, it should be understood that the supports 100 according to the present disclosure may generally be positioned at any location along or about the periphery of the one of the transition piece 56 or the impingement sleeve 50.

For example, a plurality of supports 100 may be provided to support the transition piece 56 and the impingement sleeve 50 relative to each other generally about the entire periphery, or at least a portion thereof, of the transition piece 56 and impingement sleeve 50. Thus, in some embodiments, for example, a plurality of supports 100 may be arranged in a generally annular array about the one of the transition piece 56 or the impingement sleeve 50, as shown in FIG. 3. For example, in some embodiments, two, four, six, eight, ten, twelve, or more supports may be spaced apart from each other in a generally annular array. Further, a plurality of supports 100 may be provided to support the transition piece 56 and the impingement sleeve 50 relative to each other generally along the entire length, or at least a portion thereof, of the transition piece 56 and impingement sleeve 50. Thus, in some embodiments, for example, a plurality of supports 100 may be arranged along the hot gas path 30 of the combustor 14 between the transition piece 56 and the impingement sleeve 50, as shown in FIG. 2. Additionally or alternatively, a plurality of supports 100 may be arranged in a plurality of arrays, and the arrays may be arranged along the hot gas path 30 of the combustor 14 between the transition piece 56 and the impingement sleeve 50.

It should be understood, however, that the present disclosure is not limited to a certain number or arrangement of supports 100. Rather, any suitable number and arrangement of supports 100 provided between the transition piece 56 and the impingement sleeve 50 is within the scope and spirit of the present disclosure.

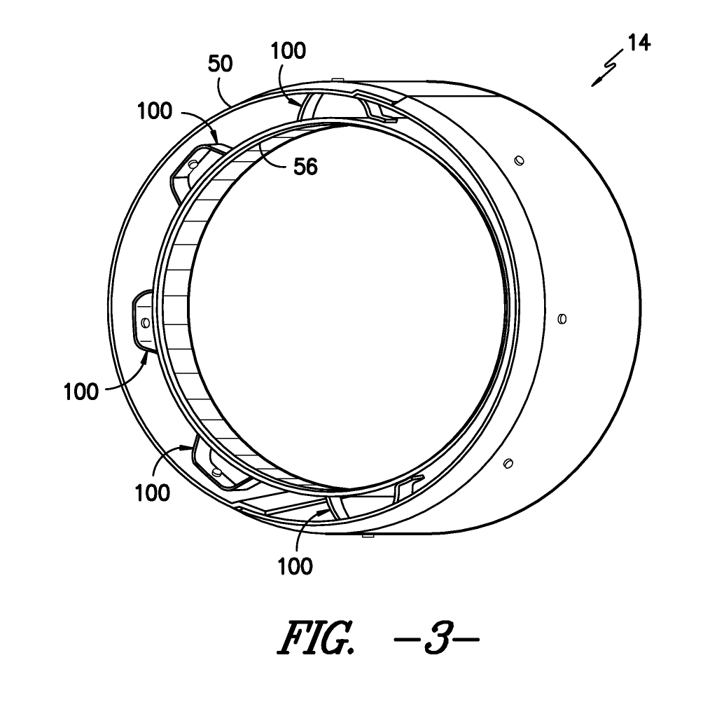

As mentioned above, the support 100 according to the present disclosure may be mounted to one of the transition piece 56 or the impingement sleeve 50. In exemplary embodiments, the support 100 may comprise a mount portion 110 or a plurality of mount portions 110 for mounting the support 100. As shown in FIGS. 4 through 8, the mount portion 110 may be, for example, a portion of the support 100 that has a contour generally similar to the contour of the transition piece 56 or the impingement sleeve 50 at the location where the support 100 is to be mounted, thus allowing for the mount between the support 100 and the one of the transition piece 56 or the impingement sleeve 50 to be a relatively firm, solid mount. Alternatively, however, the mount portion 110 may have any suitable contour, and may generally be any portion of the support 100 that is provided for mounting the support to the one of the transition piece 56 or the impingement sleeve 50.

The support 100, such as the mount portion 110, may be mounted to the one of the transition piece 56 or the impingement sleeve 50 through any suitable mounting device or process. In some embodiments, for example, a suitable mechanical fastener and/or a suitable weld may be utilized to mount the support 100. Suitable mechanical fasteners may include, for example, nut-bolt combinations, rivets, screws, nails, or any other suitable mechanical fastening devices. Suitable welds may be applied utilizing any suitable welding technique.

For example, FIGS. 4, 6, and 8 illustrate one example of a suitable mechanical fastener, a rivet 112, which may be utilized for mounting the support 100. Further, FIGS. 4, 6 and 8 illustrate a weld 114, which may be utilized alone or in combination with a suitable mechanical fastener, such as the rivet 112 as shown, for mounting the support 100. Thus, in FIGS. 4, 6, and 8, the rivet 112 is utilized to initially mount the support 100, and the weld 114 is then applied to further secure the mount. The weld 114 may be applied to the exterior surface of the one of the transition piece 56 or the impingement sleeve 50, as shown, and/or may be applied to the interior surface of the one of the transition piece 56 or the impingement sleeve 50. It should be understood that, in alternative embodiments, the rivet 112 may be utilized alone to mount the support 100.

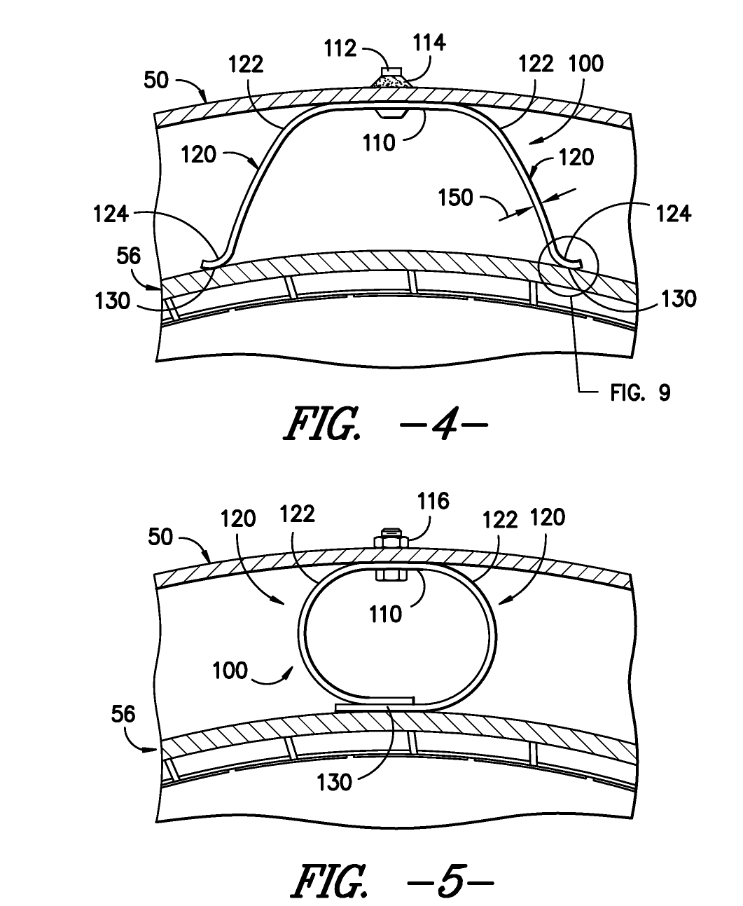

FIG. 5 illustrates another example of a suitable mechanical fastener, a nut-bolt combination 116, which may be utilized for mounting the support 100. It should be understood that the nut-bolt combination 116, as well as any other suitable mechanical fastener, may be utilized alone or in combination with a suitable weld 114 or other mounting device or process to mount the support 100.

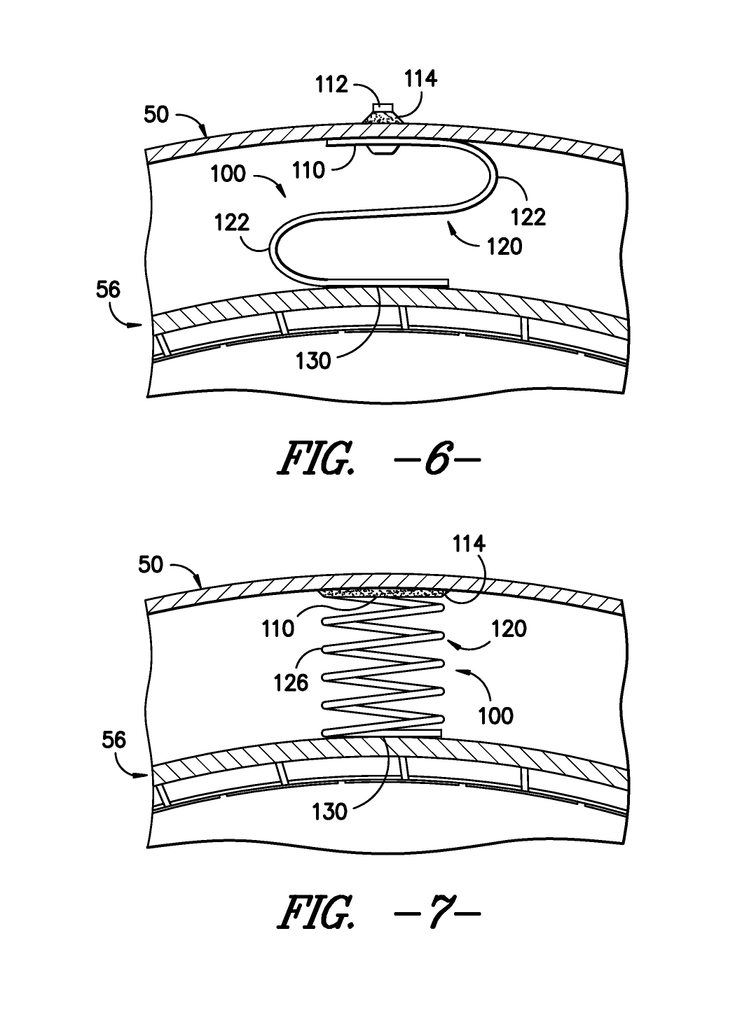

FIG. 7 illustrates another embodiment wherein a weld 114 is utilized to mount the support 100. In this embodiment, the weld 114 is applied to the interior surface of the one of the transition piece 56 or the impingement sleeve 50 to mount the support 100.

Thus, in some embodiments, at least one of mechanical fastening or welding may be utilized to mount the support 100 to the one of the transition piece 56 or the impingement sleeve 50. However, it should be understood that the present disclosure is not limited to mechanical fastening and/or welding, and rather that any suitable mounting device or process utilized to mount the support 100 to the one of the transition piece 56 or the impingement sleeve 50 is within the scope and spirit of the present disclosure.

As discussed above, the support 100 may further include a resilient portion 120 or a plurality of resilient portions 120. The resilient portion 120 according to the present disclosure may be configured to provide dampening and stiffness between the transition piece 56 and the impingement sleeve 50. For example, the resilient portion 120 may be any suitable portion of the support 120 having a suitable shape, thickness, stiffness, material, and/or other suitable characteristic that allows this portion to act as a generally elastic mechanism capable of storing mechanical energy and thus providing suitable dampening characteristics. In exemplary embodiments, the resilient portion 120 may act similar to a compression spring, although it should be understood that tension springs, torsion springs, and any other suitable springs or other suitable resilient mechanisms or materials are within the scope and spirit of the present disclosure. By providing such suitable dampening characteristics, the resilient portion 120 may thus reduce the vibrations of the transition piece 56 and/or the impingement sleeve 50 relative to each other. Additionally, the resilient portion 120 may thus accommodate thermal expansion of the transition piece 56 and the impingement sleeve 50 relative to each other, and may further maintain a relatively tight fit with tight tolerances between the transition piece 56 and the impingement sleeve 50. Further, the stiffness of the resilient portion 120 may provide support for the impingement sleeve 50 relative to the transition piece 56.

In some embodiments, as shown in FIGS. 4 through 6 and 8, the resilient portion 120 may include at least one generally arcuate portion or a plurality of generally arcuate portions. For example, FIGS. 4 and 8 illustrate one embodiment of a support 100 having two resilient portions 120 spaced apart by and extending from a mount portion 110. Each of the resilient portions 120 includes a plurality of generally arcuate portions. Further, the generally arcuate portions of each resilient portion 120 include a generally convex portion 122 and a generally concave portion 124.

FIG. 5 illustrates another embodiment of a support 100 having two resilient portions 120 spaced apart by and extending from a mount portion 110. Each of the resilient portions 120 includes a generally arcuate portion. Further, the generally arcuate portion is a generally convex portion 122. It should be understood, however, that in alternative embodiments, the arcuate portion could be a generally concave portion 124.

FIG. 6 illustrates another embodiment of a support 100 having one resilient portion 120 extending from a mount portion 110. The resilient portion 120 includes a plurality of generally arcuate portions. Further, the generally arcuate portions are generally convex portions 122, such that the resilient portion 120 according to this embodiment is generally S-shaped. It should be understood, however, that in alternative embodiments, one or more of the arcuate portion could be a generally concave portion 124.

In alternative embodiments, as shown in FIG. 7, the resilient portion 120 may be a coil spring 126. The coil spring 126 may extend from the a mount portion 110, or the mount portion 110 may simply be that portion of the coil spring 126 that is mounted to the one of the transition piece 56 or the impingement sleeve 50.

It should be understood that the resilient portion 120 is not limited to any of the above disclosed examples, and rather that any suitable resilient mechanism or material configured to provide suitable damping and stiffness characteristics between the transition piece 56 and the impingement sleeve 50 is within the scope and spirit of the present disclosure.

Further, it should be understood that the shape, thickness, stiffness, material, and/or other suitable characteristics of the resilient portion 120 may be adjusted as desired or required to provide desired damping and stiffness characteristics for the support 100 to, for example, desirable reduce vibrations. Additionally, these various characteristics may be adjusted as desired to provide desired characteristics with regard to thermal expansion of the transition piece 56 and/or the impingement sleeve 50 and with regard to maintaining a relatively tight fit with tight tolerances between the transition piece 56 and the impingement sleeve 50. Various exemplary embodiments of various of these characteristics may be discussed below.

As mentioned above, the support 100 according to the present disclosure may be configured to contact the other of the transition piece 56 or the impingement sleeve 50. In exemplary embodiments, the support 100 may comprise a contact portion 130 or a plurality of contact portions 130 for contacting the other of the transition piece 56 or the impingement sleeve 50. The contact portion 130 may generally be any portion of the support 100 that is positioned to come into contact with the other of the transition piece 56 or the impingement sleeve 50 when the support 100 is mounted to the one of the transition piece 56 or the impingement sleeve 50. In exemplary embodiments, the contact portion 130 may be allowed to move relative to the other of the transition piece 56 or the impingement sleeve 50. Thus, when the transition piece 56 and/or the impingement sleeve 50 vibrate or are subject to thermal expansion, the contact portion 130 may move to accommodate this vibration and/or thermal expansion. The contact portion 130 may, for example, slide along the surface of the other of the transition piece 56 or the impingement sleeve 50, and/or the contact portion 130 may intermittently contact the surface of the other of the transition piece 56 or the impingement sleeve 50, due to vibration and/or thermal expansion.

In some exemplary embodiments, as shown in FIGS. 4 and 9, the support 100 may further comprise a wear coating 140. The wear coating 140 may be disposed on at least a portion of the contact portion 130. Further, in some embodiments, the other of the transition piece 56 or the impingement sleeve 50 may further comprise a wear coating 140. The wear coating 140 may be disposed on the other of the transition piece 56 or the impingement sleeve 50 generally at the location where the contact portion 130 may contact the other of the transition piece 56 or the impingement sleeve 50. The wear coatings 140 may be configured to reduce wearing during contact between the contact portion 130 and the other of the transition piece 56 or the impingement sleeve 50. For example, the wear coatings 140 may be formed from any suitable material that increases wear resistance or friction between the contact portion 130 and the other of the transition piece 56 or the impingement sleeve 50 during contact, thus preventing wearing of the contact portion 130 and/or the other of the transition piece 56 or the impingement sleeve 50. In exemplary embodiments, for example, a wear coating 140 may be formed from cobalt or a cobalt-based alloy. In further exemplary embodiments, a wear coating 140 may be formed from, for example, a cobalt-chromium alloy, and may contain, for example, tungsten, molybdenum, and/or carbon, or may be another suitable alloy composed of various amounts of cobalt, nickel, iron, aluminum, boron, carbon, chromium, manganese, molybdenum, phosphorus, sulphur, silicon, and/or titanium. It should be understood, however, that the present disclosure is not limited to the above disclosed materials, and rather that any suitable materials or combinations of materials are within the scope and spirit of the present disclosure.

As discussed above, the support 100 according to the present disclosure may be formed from any suitable materials. For example, the support 100, such as the mount portion or portions 110, the resilient portion or portions 120, and/or the contact portion or portions 130, may in exemplary embodiments be formed from a suitable nickel-based alloy or superalloy, chromium-based alloy or superalloy, or nickel-chromium-based allow or superalloy. It should be understood, however, that the present disclosure is not limited to the above disclosed materials, and rather that any suitable materials or combinations of materials are within the scope and spirit of the present disclosure.

As further discussed above, the support 100 according to the present disclosure may have any suitable thickness. For example, the support 100, such as the mount portion or portions 110, the resilient portion or portions 120, and/or the contact portion or portions 130, may have a thickness 150. The thickness 150 may, in various exemplary embodiments, be in the range between approximately 30 millimeters and approximately 2.5 millimeters, such as between approximately 30 millimeters and approximately 5 millimeters, such as between approximately 6.5 millimeters and approximately 2.5 millimeters, such as between approximately 6.5 millimeters and approximately 5 millimeters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A support between a transition piece and an impingement sleeve in a combustor, the support comprising:
a resilient portion, the resilient portion configured to provide dampening between the transition piece and the impingement sleeve;
a mount portion configured for mounting the support to one of the transition piece or the impingement sleeve; and
a contact portion configured for contacting the other of the transition piece or the impingement sleeve.

2. The support of claim 1, wherein the mount portion is mounted to the one of the transition piece or impingement sleeve through at least one of mechanical fastening or welding.

3. The support of claim 1, further comprising a wear coating disposed on at least a portion of the contact portion, the wear coating configured to reduce wearing during contact between the contact portion and the other of the transition piece or the impingement sleeve.

4. The support of claim 3, wherein the wear coating is formed from cobalt or a cobalt-based alloy.

5. The support of claim 1, wherein the resilient portion, mount portion, and contact portion have a thickness in the range between approximately 30 millimeters and approximately 2.5 millimeters.

6. The support of claim 1, wherein the resilient portion comprises a generally arcuate portion.

7. The support of claim 1, further comprising a plurality of resilient portions.

8. The support of claim 1, wherein the resilient portion, mount portion, and contact portion are formed from inconel or an inconel-based alloy.

9. A combustor, comprising:
a transition piece;
an impingement sleeve surrounding at least a portion of the transition piece; and
a generally resilient support mounted to one of the transition piece or the impingement sleeve and configured to contact the other of the transition piece or the impingement sleeve.

10. The combustor of claim 9, further comprising a plurality of supports arranged in a generally annular array about the one of the transition piece or the impingement sleeve.

11. The combustor of claim 9, further comprising a plurality of supports arranged in a plurality of generally annular arrays about the one of the transition piece or the impingement sleeve, the plurality of generally annular arrays arranged along a hot gas path of the combustor.

12. The combustor of claim 9, the support comprising a mount portion configured for mounting the support to the one of the transition piece or the impingement sleeve.

13. The combustor of claim 9, wherein the support is mounted to the one of the transition piece or the impingement sleeve through at least one of mechanical fastening or welding.

14. The combustor of claim 9, wherein the support is mounted to the impingement sleeve.

15. The combustor of claim 9, wherein the support is formed from inconel or an inconel-based alloy.

16. The combustor of claim 9, the support comprising a contact portion configured for contacting the other of the transition piece or the impingement sleeve.

17. The combustor of claim 9, the support and the other of the transition piece or the impingement sleeve each comprising a wear coating, the wear coatings configured to reduce wearing during contact between the support and the other of the transition piece or the impingement sleeve.

18. The combustor of claim 17, wherein the wear coating is formed from cobalt or a cobalt-based alloy.

19. The combustor of claim 9, wherein the support has a thickness in the range between approximately 30 millimeters and approximately 2.5 millimeters.

20. A combustor, comprising:
a transition piece;
an impingement sleeve surrounding at least a portion of the transition piece; and
resilient means for resiliently supporting one of the transition piece or the impingement sleeve relative to the other of the transition piece or the impingement sleeve.
